(19) United States
(12) Patent Application Publication
(10) Pub. No.: US 2020/0150079 A1
(43) Pub. Date: May 14, 2020

(54) GAS SENSOR

(71) Applicant: DENSO CORPORATION, Kariya-city (JP)

(72) Inventors: Kouji MORITA, Kariya-city (JP); Yoshihiko KOYANAGI, Nagoya-shi (JP); Hiroyuki TAKABAYASHI, Nagoya-shi (JP)

(21) Appl. No.: 16/740,825

(22) Filed: Jan. 13, 2020

Related U.S. Application Data
(63) Continuation of application No. PCT/JP2018/026584, filed on Jul. 13, 2018.

(30) Foreign Application Priority Data
Jul. 14, 2017 (JP) 2017-138355

(51) Int. Cl. G01N 27/407; G01M 15/10; G01N 27/406

(52) U.S. Cl. CPC G01N 27/4078; G01N 27/4067; G01M 15/104

(57) ABSTRACT

A gas sensor includes a housing including a retaining hole, a sensor element including a solid electrolyte and electrodes, an insulator, which retains the sensor element and is located in the retaining hole, and a sealing member, which is formed of a ceramic powder that fills a gap between the retaining hole and the insulator. In the gas sensor, a crimped portion of the housing compresses the sealing member, and the sealing member seals the gap. The housing is formed of ferritic stainless steel the 0.2% proof stress of which is 80 MPa or more at 650° C.

### CROSS-REFERENCE TO RELATED APPLICATION

This application is a U.S. application under 35 U.S.C. 111(a) and 363 that claims the benefit under 35 U.S.C. 120 from International Application No. PCT/JP2018/026584 filed on Jul. 13, 2018, the entire contents of which are incorporated herein by reference. This application is also based on and claims the benefit of priority from earlier Japanese Patent Application No. 2017-138355 filed Jul. 14, 2017, the description of which is incorporated herein by reference.

### BACKGROUND

### Technical Field

The present disclosure relates to a gas sensor.

### Background Art

Gas sensors include, for example, air-fuel ratio sensors, oxygen sensors, and NOx sensors that detect the air-fuel ratio, the oxygen concentration, and the concentration of a specific gas component such as NOx in exhaust gas discharged from an internal combustion engine.

In a gas sensor, a sensor element is provided in a retaining hole of a housing alone or via an insulator. A sealing member such as talc that fills a gap between the retaining hole and the sensor element or the insulator is compressed by a crimped portion of the housing. Thus, the sensor element is retained by the housing, and the airtightness of the gap in which the sealing member is located is ensured.

There has been known a technique that changes the composition of the housing, for example. The housing contains Fe as a principal component, at least 0.02 to 0.15% of C by mass, 11.5 to 18.0% of Cr by mass, and Nb by twice the mass of C or more.

### SUMMARY

One aspect of the present disclosure provides a gas sensor including a housing, a sensor element, and a sealing member. The housing 2 includes a retaining hole. The sealing member is formed of a ceramic powder that fills a gap between the retaining hole and the sensor element or the insulator. The housing is formed of ferritic stainless steel having a 0.2% proof stress of 80 MPa or more at 650° C.

Another aspect of the present disclosure provides a gas sensor including a housing, a sensor element, and a sealing member. The housing includes a retaining hole. The material constituting the housing is formed of ferritic stainless steel containing, by mass, 15 to 25% of Cr, 0.01 to 1.0% of Nb, 0.5 to 4% of at least one of W and Mo alone or in total, and the balance: Fe and inevitable impurities including C, N, Mn and Si.

Reference signs in parentheses used for components in one aspect of the present disclosure indicate the correspondence to reference signs in the drawing of the embodiment and do not limit the components to only the contents of the embodiment.

### BRIEF DESCRIPTION OF THE DRAWINGS

The above-described object, features, and advantages will become more apparent by the following detailed description with reference to the accompanying drawings in which:

FIG. 1 is an explanatory diagram illustrating a cross-section of a gas sensor according to an embodiment;

FIG. 2 is a partially enlarged explanatory diagram illustrating the cross-section of the gas sensor according to the embodiment;

FIG. 3 is an explanatory diagram illustrating the cross-section of a sensor element of the gas sensor according to the embodiment;

FIG. 4 is an explanatory diagram illustrating the cross-section of another gas sensor according to an embodiment;

FIG. 5 is a graph showing the relationship between the material constituting a housing and the yield point according to Test 1 of a verification test;

FIG. 6 is a graph showing the relationship between the temperature of the housing and the yield point according to Test 3 of the verification test;

FIG. 7 is a graph showing the relationship between the heat treatment temperature of the housing and the yield point at room temperature according to Test 4 of the verification test;

FIG. 8 is a graph showing the relationship between the annealing temperature and the precipitation amount of Laves phase according to Test 5 of the verification test; and

FIG. 9 is a graph showing the leakage amount that occurred in the housing according to Test 7 of the verification test.

### DETAILED DESCRIPTION OF THE PREFERRED EMBODIMENTS

In the gas sensor that uses air as a reference gas, while the exhaust gas that flows through the exhaust pipe of an internal combustion engine is introduced to a detecting section of the sensor element, which projects from the housing, the air taken in from outside of the exhaust pipe is introduced to the inside of the sensor element. Since the pressure of the exhaust gas is higher than atmospheric pressure, ensuring the airtightness of the gap in which the sealing member is located prevents the exhaust gas from being mixed with the air in the sensor element through the gap.

JP 2009-198422 A discloses a technique that changes the composition of the housing, for example. In PTL 1, the housing contains Fe as a principal component, at least 0.02 to 0.15% of C by mass, 11.5 to 18.0% of Cr by mass, and Nb by twice the mass of C or more.

The temperature of the mounting environment of a gas sensor that is used as an exhaust sensor under an environment where exhaust gas exists has increased due to the influence of, for example, downsizing for improving the vehicle fuel efficiency and the mounting of an exhaust purifying catalyst near the engine for increasing the temperature at an early stage. In general, to match the coefficient of thermal expansion of the housing and the coefficient of thermal expansion of the exhaust pipe constituted by ferritic stainless steel, a ferritic stainless steel such as grade 430 is used for the housing. The housing formed of grade 430 stainless steel is excellent in processability but has the drawback that it has a significantly decreased strength at 550° C. or more.

For this reason, for example, under an environment in which the temperature of the crimped portion of the housing reaches 650° C., permanent deformation of the housing at, for example, the crimped portion decreases the compression force on the sealing member such as talc. Depending on circumstances, the exhaust gas in the exhaust pipe may possibly mix with the air introduced to the inside of the sensor element through the gap in which the sealing member is located.

Some of the air-fuel ratio sensors include an air duct that introduces air to the inside of the sensor element. In such an air-fuel ratio sensor, when the air-fuel ratio is in a fuel-rich condition, unburnt gas causes a chemical reaction on the electrode exposed to the exhaust gas. Accordingly, oxide ions (O²⁻) move from the electrode exposed to the air to the electrode exposed to the exhaust gas through the solid electrolyte, so that the air-fuel ratio in the fuel-rich condition is detected.

In the air-fuel ratio sensor including the air duct, if the exhaust gas mixes with the air introduced to the inside of the sensor element when the air-fuel ratio is in the fuel-rich condition, the oxygen concentration in the air decreases. This may possibly hinder the oxide ions (O²⁻) from being transferred from the electrode exposed to the air to the electrode exposed to the exhaust gas through the solid electrolyte. In this case, the coverage of the detection range in which the air-fuel ratio in the fuel-rich condition can be detected may possibly be narrowed.

Additionally, contact terminals are provided inside the gas sensor. The contact terminals electrically connect the sensor element and a heater that heats the sensor element to the outside of the gas sensor. If the exhaust gas mixes in the air that is introduced to the inside of the sensor element, the exhaust gas may possibly reach the contact terminals. In this case, the contact terminals may possibly cause corrosion by, for example, moisture and a nitrogen compound in the exhaust gas.

Thus, to ensure the coverage of the detection range in which the air-fuel ratio in the fuel-rich condition can be detected, or to ensure the corrosion resistance of the contact terminals, it is important to ensure the airtightness of the gap in which the sealing member is located even under high-temperature environments of 550° C. or more. It was found that a further change is necessary in the composition of the material constituting the housing to suppress a decrease in the strength of the crimped portion of the housing.

The present disclosure aims to provide a gas sensor that suppresses permanent deformation of a housing and ensures airtightness of the gas sensor under high-temperature environments.

One aspect of the present disclosure provides a gas sensor including a housing, a sensor element, and a sealing member. The housing includes a retaining hole. The sensor element includes a solid electrolyte and electrodes located on both sides of the solid electrolyte. The sensor element is inserted in the retaining hole alone or via an insulator. The sealing member is formed of a ceramic powder that fills a gap between the retaining hole and the sensor element or the insulator. The sealing member is compressed by part of the housing, so that the gap is sealed. The housing is formed of ferritic stainless steel having a 0.2% proof stress of 80 MPa or more at 650° C.

Another aspect of the present disclosure provides a gas sensor including a housing, a sensor element, and a sealing member. The housing includes a retaining hole. The sensor element includes a solid electrolyte and electrodes located on both sides of the solid electrolyte. The sensor element is inserted in the retaining hole alone or via an insulator. The sealing member is formed of a ceramic powder that fills a gap between the retaining hole and the sensor element or the insulator. The sealing member is compressed by part of the housing, so that the gap is sealed. The material constituting the housing is formed of ferritic stainless steel containing, by mass, 15 to 25% of Cr, 0.01 to 1.0% of Nb, 0.5 to 4% of at least one of W and Mo alone or in total, and the balance: Fe and inevitable impurities including C, N, Mn and Si.

According to the gas sensor of the first aspect, since the housing is formed of ferritic stainless steel that has a 0.2% proof stress (which may hereafter be simply referred to as the proof stress) of 80 MPa or more at 650° C., a decrease in the strength of the housing under high-temperature environments of 550° C. or more is suppressed. With this configuration of the housing, even under high-environments of 550° C. or more, the force with which part of the housing compresses the sealing member is maintained, and the airtightness of the gap between the retaining hole of the housing and the sensor element or the insulator obtained by the sealing member is maintained.

Consequently, the gas sensor of the first aspect suppresses the permanent deformation of the housing and ensures the airtightness of the gas sensor under high-temperature environments.

The gas sensor of the other aspect suppresses the decrease in the strength of the housing under high-temperature environments of 550° C. or more by changing the composition of the housing. The material constituting the housing increases the yield point of the material at high temperatures of 550° C. or more while maintaining the low thermal expansion, which is a property of ferritic stainless steel containing 15 to 25% of Cr (chromium) by mass in Fe (iron) to resist expansion even when being heated.

More specifically, to increase the yield point of the material at high temperatures of 550° C. or more, the material constituting the housing contains, by mass, 0.01 to 1.0% of Nb (niobium) and 0.5 to 4% of at least one of W (tungsten) and Mo (molybdenum) alone or in total in Fe besides Cr. This suppresses the permanent deformation of the housing at high temperatures of 550° C. or more. As a result, even under high-temperature environments of 550° C. or more, the force that part of the housing compresses the sealing member is maintained, and the airtightness of the gap between the retaining hole of the housing and the sensor element or the insulator obtained by the sealing member is maintained.

Consequently, the gas sensor of the other aspect also reduces the permanent deformation of the housing and ensures the airtightness of the gas sensor under high-temperature environments.

A gas sensor according to a preferred embodiment will be described.

As a method for increasing the yield point of material at a high temperature, which is the high-temperature strength, a precipitation strengthening method and a substitutional solid solution strengthening method are generally known as being effective. It is generally known that the precipitation strengthening method strengthens the material by precipitation of carbide or nitride caused by adding elements such as Nb, Mo, W, Si, and Cu. Since the precipitation strengthening method significantly increases the high-temperature strength, the method is effective in increasing the airtightness under high-temperature environments.

However, with the precipitation strengthening method, under high-temperature environments in which the gas sensor serving as an exhaust sensor is used, the material constituting the housing may undesirably precipitate, which causes the material to become brittle. Additionally, with the precipitation strengthening method, when a crimping process using electric heating is performed on the housing, the precipitate may dissolve, so that the effect of improving the high-temperature strength of the material is not achieved. Furthermore, while the precipitation strengthening method increases the yield point of the material at high temperatures, the processability, such as the deformation resistance, the elongation, and the toughness of the material at room temperature significantly deteriorates. For these reasons, the manufacture of the housing through cold forging becomes difficult, and the production costs of the housing may possibly increase.

In the substitutional solid solution strengthening method, there is little concern about the embrittlement of the material under high-temperature environments and the loss of the improvement effect of the high-temperature strength of the material. Further, the method suppresses the deterioration of the processability of the material. This suppresses deterioration of the cold forging processability necessary for the housing.

The index of the cold forging processability includes the deformation resistance, the elongation, and the toughness at room temperature. The elements that are used in the substitutional solid solution strengthening may be Nb, W, Mo, Ta, and V. Additionally, the processability at room temperature can be improved by annealing besides the reduction in carbon content and the reduction in nitrogen content.

The manufacture of the housing is facilitated by methods such as warm forging and cutting. However, the methods are not suitable for a gas sensor that is to be mass produced, in view of the manufacturing costs. The manufacture of the housing by cold forging is more suitable in view of the manufacturing costs. Furthermore, it is effective to manufacture the housing by cold forging to increase the hardness so as not damage the shape of a thread section or a hexagonal section of the housing by the fastening force when the gas sensor is mounted on, for example, the exhaust pipe. According to the cold forging, at least part of the housing exhibits a hardness of Hv220 or more through work hardening of the material of the housing. Therefore, it is important to ensure the processability at room temperature.

In the gas sensor of the one aspect, the material constituting the housing may contain, by mass, 15 to 25% of Cr, 0.01 to 1.0% of Nb, and 0.5 to 2% of at least one of W and Mo alone or in total, and the balance may be constituted by Fe and inevitable impurities including C, N, Mn, and Si.

In this case, by changing the composition of the housing, a material having a proof stress of 80 MPa or more at 650° C. is formed. The material constituting the housing increases the yield point of the material at high temperatures of 550° C. or more while maintaining low thermal expansion, which is the property of ferritic stainless steel containing 15 to 25% of Cr (chromium) by mass in Fe (iron) to resist expansion even when being heated.

More specifically, to increase the yield point of the material at high temperatures of 550° C. or more, the material constituting the housing contains, by mass, 0.01 to 1.0% of Nb (niobium) and 0.5 to 2% of at least one of W (tungsten) and Mo (molybdenum) alone or in total in Fe besides Cr. This improves the proof stress at high temperatures of 550° C. or more. The increase in the proof stress or the relaxation resistance (stress relaxation and wear-and-tear resistance) under higher-temperature environments suppresses the permanent deformation of the housing. As a result, even under high-temperature environments of 550° C. or more, the crimped portion of the housing maintains the force to compress the sealing member, so that the sealing member maintains the airtightness of the gap between the retaining hole of the housing and the sensor element or the insulator.

Consequently, the composition of the material forming the housing as described above suppresses the permanent deformation of the housing and ensures the airtightness of the gas sensor under high-temperature environments. Ensuring the airtightness ensures, for example, the coverage of the detection range in which the air-fuel ratio in the fuel-rich condition can be detected and the corrosion resistance of the contact terminals.

Even if steel to which the solid solution strengthening element is added undergoes solid solution treatment, the deterioration of the processability from the original material is inevitable. In regard to the deformation resistance and the elongation, it is generally known that intermediate annealing during cold forging is effective to facilitate the processing. However, there is a contradiction that the intermediate annealing increases the energy necessary for processing, which increases the processing costs, and the component may be deformed by external force during mounting since the hardness as the component is insufficient.

As means for improving the toughness, it is generally known to be effective to subject an unprocessed material of the housing to a wire drawing process multiple times to make crystals become finer. However, in this case also, there is a contradiction that the processing costs are increased. As means for improving the toughness, it is also known to be effective to, for example, warm up before forging. However, in this case also, there is a contradiction that the processing costs are increased, and controlling the temperature involves a cost.

Additionally, the toughness can be improved by adding 0.15 to 0.6% of Ni by mass to the material of the housing. However, in this case, since the deformation resistance is increased, the processing rate during the forging process cannot be increased, resulting in an increase in the manufacturing costs.

Therefore, which of the above-mentioned means to select depends on the design.

Hereinafter, the chemical composition will be described.

### (Content of Cr)

The content of Cr in the entire material constituting the housing is 15 to 25% by mass. This ensures, for example, the oxidation resistance, the corrosion resistance, and the low thermal expansion achieved by the ferritic stainless steel. If the content of Cr is less than 15% by mass, the material of the housing may possibly fail to sufficiently exhibit properties such as the oxidation resistance and the corrosion resistance. If the content of Cr exceeds 25% by mass, the toughness decreases as the deformation resistance increases, and the processability may possibly deteriorate. Considering the fact that the housing is formed by cold forging, the content of Cr is preferably 21% or less by mass, and more preferably 18% or less by mass. The content of Cr is a matter of design set as required in the range that ensures the properties such as the oxidation resistance and the processability.

### (Content of Nb)

Since the material constituting the housing contains Nb, the yield point of the material at high temperatures of 550° C. or more is increased. Additionally, since the material constituting the housing contains Nb, sensitization is suppressed. Stoichiometrically, the content of Nb equal to the content of C and N is necessary for sensitization resistance. However, since the chemical bonding between Nb with C and N is a stochastic event, the Nb needs to be present in excess to some extent. For example, it is generally known that the content of Nb is preferably three times the total content of C and N as the requirement for 430LX stainless steel.

Additionally, since the material constituting the housing contains Nb, fine crystals of NbC are formed. The fine crystal serves as the starting point to suppress the coarsening of the structure during the heat treatment and the deterioration of the toughness.

It is known that the improvement in the proof stress of the material at high temperatures of 550° C. or more achieved by containing Nb is saturated at approximately 1.0% by mass. The greater the content of Nb, the greater the deformation resistance becomes, and the worse the processability of the housing becomes. Therefore, it is preferred not to contain more Nb than necessary. Considering the fact that the housing is formed by cold processing, the content of Nb is preferably 1.0% or less by mass, and more preferably 0.5% or less by mass.

If the content of Nb becomes less than 0.01% by mass, there is a possibility that the advantage of containing Nb is not achieved.

### (Content of W and Mo)

Since the material constituting the housing contains at least one of W and Mo, the proof stress of the material at high temperatures of 550° C. or more is increased.

If the content of at least one of W and Mo alone or in total is less than 0.3% by mass, the advantage of increasing the yield point of the material at high temperatures of 550° C. or more is not sufficiently achieved. If the content of at least one of W and Mo alone or in total exceeds 2% by mass, the deformation resistance of the material is increased, so that the processability of the housing may possibly deteriorate.

While the sublimation temperature of an oxide of Mo (Mo₃O) is approximately 700° C., the sublimation temperature of an oxide of W (WO₃) is approximately 1000° C. Thus, as the material constituting the housing, it is preferable to use W with a higher sublimation temperature. Furthermore, the atomic weight of W is greater than the atomic weight of Mo, and W is less likely to diffuse compared with Mo. When the material contains W, the creep resistance of the material is expected to improve, and the relaxation resistance is also expected to improve.

Elements such as Ta (tantalum) and V (vanadium) are also known as elements that increase the yield point of the material constituting the housing at high temperatures. Note that, due to availability and economic factors, the material constituting the housing preferably contains any of Nb, W, and Mo alone or in combination.

### (Content of Mn and Si)

Mn (manganese) and Si (silicon) suppress exfoliation of an oxide film and improve high-temperature oxidation resistance. In particular, when an emphasis is put on the high-temperature oxidation resistance, it is effective to set the content of each of Mn and Si in the material constituting the housing to 0.05% or more by mass. It is known that increasing the content of Mn and Si deteriorates the brittleness. For this reason, in the case of the material of the present housing that needs to maintain the cold processability, it is desirable that the content of Mn and Si be small. The total content of Mn and Si is preferably 2.0% or less by mass, and more preferably 1.5% or less by mass.

### (Content of P and S)

While S (sulfur) is known as a free-cutting component during cutting, it is an inevitable impurity that is difficult to reduce. If the content of P (phosphorus) and S is large, they might decrease the corrosion resistance and become the cause of blowholes during welding. Thus, the content of P (phosphorus) and S is preferably small. The content of P and S in the material constituting the housing is desirably controlled to 0.07% or less by mass, and more preferably 0.05% or less by mass.

### (Content of C and N)

C (carbon) is a typical solid-solution element. Additionally, C forms a carbide with elements such as Nb and Ti, so that crystal grain growth is suppressed. To achieve this effect, the content of C in the material constituting the housing needs to be 0.001% or more by mass. C and N (nitrogen) are inevitable impurities that are difficult to reduce and cause deterioration of the cold processability and the toughness and deterioration of the corrosion resistance. Thus, the content of C and N is preferably 0.12% or less by mass in total, and more preferably 0.03% or less by mass alone.

### (Content of Ni)

Like Cu, Ni (nickel) is an element that improves low-temperature toughness. In other words, Ni (nickel) lowers ductile brittle transition temperature of the material constituting the housing to facilitate the cutting and the cold forging of the housing. To achieve such an effect, the content of Ni is preferably 0.1% or more by mass.

If the content of Ni is increased, the deformation resistance is increased, so that the processability deteriorates. Furthermore, since Ni is an austenite stabilizing element, if the content is excessive, an austenite structure may possibly be generated in part of the material. For this reason, the coefficient of thermal expansion may undesirably increase, and two-phase stainless steel in which an austenite structure is mixed with a ferrite structure may undesirably be generated. This may possibly deteriorate the processability of the material significantly. As above, the material constituting the housing may contain 0.1 to 0.6% of Ni by mass.

### (Content of Al)

The material constituting the housing may further contain 0.15 to 0.6% by mass of at least one of Al and Ti alone or in total.

Since the material constituting the housing contains at least one of Al (aluminum) and Ti (titanium), the oxidation resistance of the material is improved. Additionally, if the material constituting the housing contains Mo, the diffusion of Mo in the material is suppressed since the material constituting the housing contains at least one of Al and Ti. This improves the creep resistance of the material.

### Embodiment

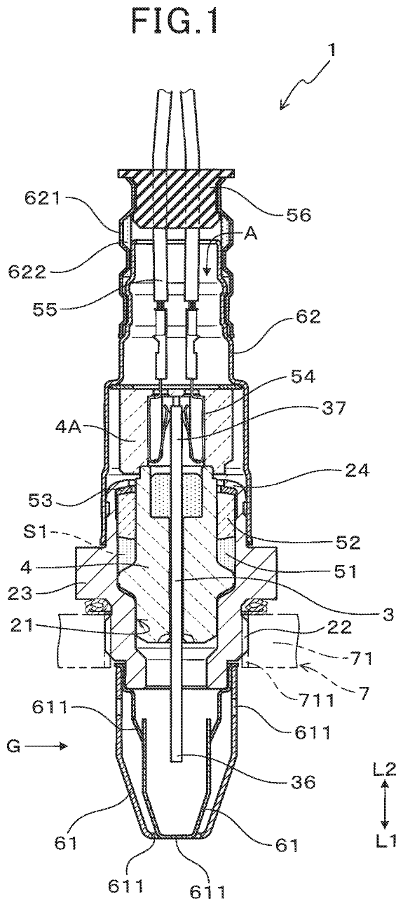

A gas sensor 1 of the present embodiment includes, as shown in FIGS. 1 to 3, a housing 2, which includes a retaining hole 21, a sensor element 3, which includes a solid electrolyte 31, electrodes 32A and 32B provided on both sides of the solid electrolyte 31, an insulator 4, which retains the sensor element 3 and located in the retaining hole 21, and a sealing member 51, which is formed of a ceramic powder that fills a gap S1 between the retaining hole 21 and the insulator 4. In the gas sensor 1, a crimped portion 24 of the housing 2 compresses the sealing member 51, so that the sealing member 51 seals the gap S1.

### (Internal Combustion Engine)

The gas sensor 1 is located in an exhaust pipe 7 of an internal combustion engine (engine) of a vehicle and detects exhaust gas G that flows in the exhaust pipe 7. The gas sensor 1 of the present embodiment is used as an A/F (air-fuel ratio) sensor, which detects the air-fuel ratio of the internal combustion engine calculated from the composition of the exhaust gas G. The gas sensor 1 may be located upstream of a section where a catalyst is located in the exhaust pipe 7.

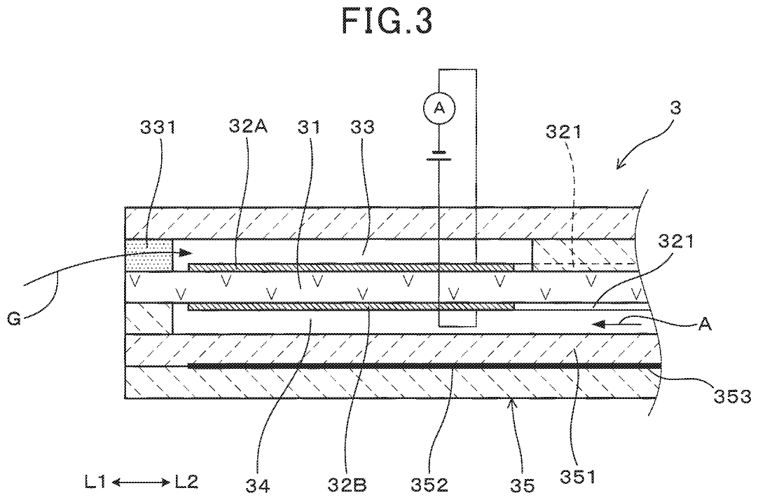

As shown in FIG. 3, in the A/F sensor, a predetermined voltage for showing limiting current characteristics is applied between a detection electrode 32A, which is located on one side of the solid electrolyte 31 and is exposed to the exhaust gas G, and a reference electrode 32B, which is located on the other side of the solid electrolyte 31 and exposed to air A. When the oxygen concentration of the exhaust gas G changes, the migration amount and the migration direction of oxide ions (O²⁻) between the detection electrode 32A and the reference electrode 32B change, and the air-fuel ratio in a fuel-rich condition and in a fuel-lean condition is detected in a predetermined detection range.

In the A/F sensor, since a voltage is applied between the detection electrode 32A and the reference electrode 32B, if the air-fuel ratio is in the fuel-lean condition, the oxide ions (O²⁻) move from the detection electrode 32A to the reference electrode 32B through the solid electrolyte 31. If the air-fuel ratio is in the fuel-rich condition, as the unburnt gas in the detection electrode 32A causes a chemical reaction, the oxide ions (O²⁻) move from the reference electrode 32B to the detection electrode 32A through the solid electrolyte 31.

The pressure of the exhaust gas G that is taken into the gas sensor 1 is often higher than the air pressure taken into the gas sensor 1. For this reason, the gap S1 between the retaining hole 21 of the housing 2 and the insulator 4 is sealed by the sealing member 51 so that the exhaust gas G taken into the gas sensor 1 does not mix with the air A taken into the gas sensor 1.

The gas sensor 1 may be an oxygen sensor, which determines whether the air-fuel ratio obtained from the composition of the exhaust gas G is in the fuel-rich condition or in the fuel-lean condition with respect to the stoichiometric air-fuel ratio through ON and OFF.

### (Sensor Element 3)

The direction in which the section of the gas sensor 1 of the present embodiment is located in the exhaust pipe 7 is referred to as a distal direction L1, and the direction opposite to the distal direction L1 is referred to a proximal direction L2.

The solid electrolyte 31 of the sensor element 3 shown in FIG. 3 includes zirconia as a principal component and is formed of stabilized zirconia or partially stabilized zirconia in which rare-earth metal elements or alkaline-earth metal elements substitute for parts of the zirconia. The solid electrolyte 31 may be constituted by, for example, yttria-stabilized zirconia or yttria-partially-stabilized zirconia. The solid electrolyte 31 has ion conductivity that conducts oxide ions (O²⁻) at a predetermined activation temperature. The electrodes 32A and 32B contain platinum that exhibits catalytic activity for oxygen and material that has the same property as the material constituting the solid electrolyte 31.

The sensor element 3 of the present embodiment is a laminated sensor element in which the electrodes 32A, 32B are located on both sides of the plate-like solid electrolyte 31, and a heater 35 is laminated on the solid electrolyte 31. The sensor element 3 is retained by the housing 2 in a state in which the sensor element 3 is inserted in the insulator 4. The heater 35 is constituted by a heating element 352 located in a ceramic substrate 351. The heating element 352 is heated by the application of electrical power.

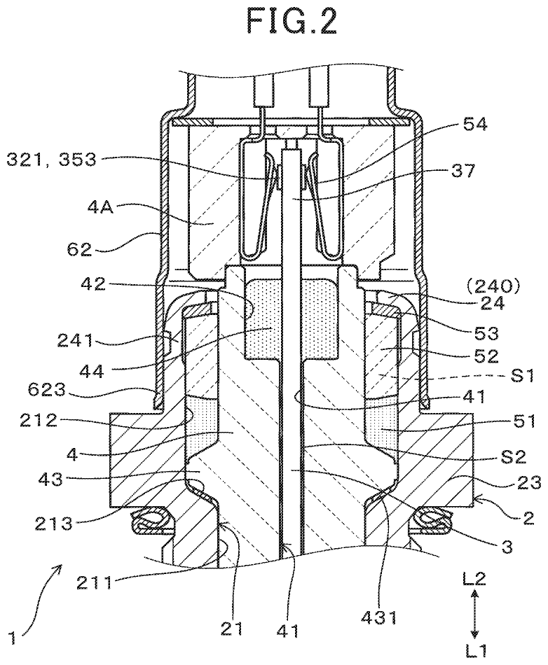

As shown in FIGS. 1 and 2, the sealing member 51 fills the gap S1 between the retaining hole 21 of the housing 2 of the present embodiment and the insulator 4. The sealing member 51 is a ceramic powder made of talc. Furthermore, an insulation member 52 such as ceramic is located to the proximal direction L2 of the sealing member 51, and a metal ring 53 is located to the proximal direction L2 of the insulation member 52. The sealing member 51, the insulation member 52, and the metal ring 53 are securely crimped by the crimped portion 24, which is formed by bending a proximal end section 240 of the housing 2 inward. In this state, the sealing member 51, the insulation member 52, and the metal ring 53 are pressed from the proximal direction L2 toward the distal direction L1.

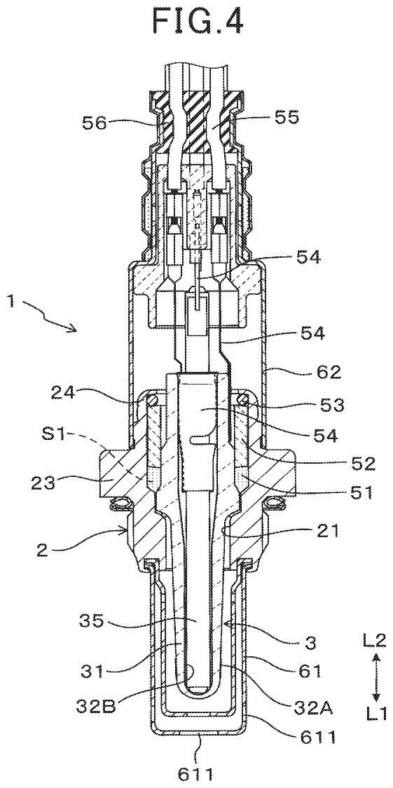

Furthermore, as shown in FIG. 4, the sensor element 3 may be cup shaped. That is, the electrodes 32A and 32B are located on the outer side and the inner side of the solid electrolyte 31 that is tubular and has a closed end, and the heater 35 is located inside the solid electrolyte 31. In this case, the insulator 4 is not used, and the sensor element 3 is directly retained by the retaining hole 21 of the housing 2. The gap S1 between the retaining hole 21 and the sensor element 3 is sealed by the sealing member 51 that receives compression force from the crimped portion 24 of the housing 2. Other structures of the gas sensor 1 of FIG. 4 are the same as those of the gas sensor 1 of FIG. 1.

### (Shape of Housing 2)

As shown in FIG. 1, the housing 2 constitutes the case of the gas sensor 1 and is a member for mounting the gas sensor 1 to the exhaust pipe 7. The housing 2 is shaped like a cylinder having the retaining hole 21 at the central portion and includes a threaded portion 22, a hexagonal flange portion 23, and the crimped portion 24. The threaded portion 22 is screwed to a threaded bore 711 provided in a mounting boss 71 of the exhaust pipe 7. The hexagonal flange portion 23 is formed adjacent to the threaded portion 22 in the proximal direction L2 and constitutes the outer circumferential surface that projects most outward. The crimped portion 24 is formed adjacent to the flange portion 23 in the proximal direction L2.

As shown in FIG. 2, the retaining hole 21 of the housing 2 includes a small-diameter bore 211, a large-diameter bore 212, which is formed to the proximal direction L2 of the small-diameter bore 211 and is larger than the small-diameter bore 211, and a step 213, which is formed between the small-diameter bore 211 and the large-diameter bore 212. The crimped portion 24 forms the large-diameter bore 212. The sealing member 51, the insulation member 52, and the metal ring 53 are located in the large-diameter bore 212.

### (Insulator 4)

The insulator 4 includes an insertion bore 41, which receives the sensor element 3, a recess 42, which is formed adjacent to the insertion bore 41 in the proximal direction L2, and a projection 43, which constitutes the outer circumferential surface that projects most outward. When the insulator 4 is located in the retaining hole 21 of the housing 2, the projection 43 is located in the large-diameter bore 212, and the projection 43 faces the step 213 via, for example, a metal member 431. The sealing member 51, the insulation member 52, and the metal ring 53 are located in the large-diameter bore 212. The sealing member 51, the insulation member 52, and the metal ring 53 are compressed between the projection 43 and the crimped portion 24 by bending the crimped portion 24 inward. Furthermore, with the sensor element 3 inserted in the insertion bore 41, insulation particles 44 such as a ceramic powder are placed in the recess 42. The sensor element 3 is retained by the insulator 4 through the insulation particles 44.

As shown in FIG. 2, in the gas sensor 1, a gap S2 between the sensor element 3 and the insertion bore 41 of the insulator 4 is sealed by the insulation particles 44, and the gap S1 between the insulator 4 and the retaining hole 21 of the housing 2 is sealed by the sealing member 51. Due to the location of the insulation particles 44 and the sealing member 51, the exhaust gas G that flows to the section of the insulator 4 in the distal direction L1 is prevented from flowing from the distal direction L1 of the insulator 4 to the proximal direction L2 through the gaps S1 and S2.

As shown in FIGS. 1 and 3, the pair of electrodes 32A and 32B are located at a distal end section 36 of the sensor element 3 to form a detecting section 361 for detecting gas. The detecting section 361 includes a diffusion resistance section 331, which introduces the exhaust gas G to the detection electrode 32A at a predetermined diffusion rate. The detection electrode 32A is located in a gas chamber 33, which is connected to the diffusion resistance section 331. Although not shown, a protection layer formed of porous ceramic is formed around the detecting section 361. The distal end section 36 of the sensor element 3 is exposed to the exhaust gas G.

As shown in FIGS. 2 and 3, lead portions 321, which are respectively connected to the pair of electrodes 32A and 32B, and a lead portion 353 of the heating element 352 of the heater 35 are drawn out to a proximal end section 37 of the sensor element 3. The distal end section 36 of the sensor element 3 projects from the insulator 4 and the housing 2 in the distal direction L1, and the proximal end section 37 of the sensor element 3 projects from the insulator 4 and the housing 2 in the proximal direction L2.

### (Contact Terminal 54)

Another insulator 4A is located to the proximal direction L2 of the insulator 4. Contact terminals 54 for the electrical connection of the sensor element 3 and the heater 35 are located on the other insulator 4A. The lead portions 321 of the electrodes 32A and 32B of the sensor element 3 and the lead portion 353 of the heating element 352 of the heater 35 extend from the distal end section 36 of the sensor element 3 and are drawn out from the proximal end section 37 of the sensor element 3. The contact terminals 54 include one that contacts the lead portions 321 of the electrodes 32A and 32B and one that contacts the lead portion 353 of the heating element 352.

The contact terminals 54 are formed of conductive metal and contact the sensor element 3 by pressing force caused by elastic deformation. A duct 34 for introducing air A to the reference electrode 32B is formed inside the sensor element 3. The duct 34 is open in the proximal end section 37 of the sensor element 3, and the air A is introduced to the reference electrode 32B from the proximal end section 37 of the sensor element 3.

### (Protection Cover 61 and Proximal End Cover 62)

As shown in FIG. 1, a protection cover 61, which covers the distal end section 36 of the sensor element 3 to protect the sensor element 3, is mounted on the section of the housing 2 in the distal direction L1. A proximal end cover 62, which accommodates components such as the contact terminals 54, the other insulator 4A, and lead wires 55 connected to the contact terminals 54, is mounted on the section of the housing 2 in the proximal direction L2. The protection cover 61 includes exhaust gas passage holes 611, through which exhaust gas G flows. The exhaust gas G flows into the protection cover 61 through the exhaust gas passage holes 611, introduced to the detection electrode 32A of the sensor element 3, and flows out to the outside of the protection cover 61 through the exhaust gas passage holes 611.

An air introduction hole 621 is formed in the proximal end cover 62. The air introduction hole 621 is provided with a filter 622, which allows air A to pass through while preventing water from passing through. The air A introduced into the proximal end cover 62 is taken into the duct 34 from the proximal end section 37 of the sensor element 3 and is introduced to the reference electrode 32B in the duct 34. The proximal end cover 62 is mounted on the outer circumference of the proximal end section 240 of the housing 2 at which the crimped portion 24 is formed. A bushing 56, which retains the lead wires 55, is located inside the proximal end section of the proximal end cover 62.

### (Composition of Housing 2)

The housing 2 of the present embodiment is formed of ferritic stainless steel with a 0.2% proof stress of 80 MPa or more at 650° C. The housing 2 increases the yield point of the material at high temperatures of 550° C. or more while maintaining the low thermal expansion property of the ferritic stainless steel containing 15 to 25% of Cr by mass in Fe.

The housing 2 of the present embodiment contains Fe (iron), Cr (chromium), Nb (niobium), Ni (nickel), and Al (aluminum) as constituent elements, and Mn (manganese), Si (silicon), C (carbon), and N (nitrogen) as inevitable impurities.

The material constituting the housing 2 has the composition including, by mass, 15 to 25% of Cr, 0.01 to 1.0% of Nb, 0.5 to 4% of W, 1.5% or less of Mn and Si, 0.1 to 0.6% of Ni, 0.15 to 0.6% of Al, 0.03% or less of C and N in total, and the balance: Fe. C, N, Mn, and Si are treated as inevitable impurities. Instead of W, Mo may be used, and W and Mo may be mixed to be used.

The crystal structure of the material constituting the housing 2 is a body-centered cubic lattice structure with the ferrite structure. The ferrite structure has the property of resisting expansion by heat compared with the austenite structure. The threaded portion 22 of the housing 2 is screwed to the threaded bore 711 of the mounting boss 71 of the exhaust pipe 7, so that the gas sensor 1 is mounted on the exhaust pipe 7. Since the exhaust gas G passing through the exhaust pipe 7 has a high temperature of 550° C. or more, the threaded portion 22 and the threaded bore 711 are heated to a high temperature of 550° C. or more.

The mounting boss 71 of the exhaust pipe 7 is often formed of ferritic stainless steel. Since the crystal structure of the housing 2 is the ferrite structure, the metal structure constituting the threaded portion 22 and the threaded bore 711 is the ferrite structure. Thus, the coefficient of thermal expansion of the threaded portion 22 and the coefficient of thermal expansion of the threaded bore 711 are close to each other. This prevents the threaded portion 22 and the threaded bore 711 from being adhered to each other by heat, or from being thermally seized.

The housing 2 of the present embodiment is formed by performing solid solution heat treatment in a raw material state before forging. The solid solution heat treatment involves dissolving a precipitate such as carbide, which may be of Nb, W, Mn, Si, Ni, and Al, into the base material, which is Fe. The solid solution heat treatment is performed by heating the material of the housing 2 to a predetermined heat treatment temperature and then cooling the material of the housing 2. If the heat treatment temperature is low, the precipitate generated during slow cooling in the material processing does not sufficiently dissolve in Fe. If the heat treatment temperature is too high, the ferrite crystal may possibly coarsen, which deteriorates the elongation and the toughness of the material.

Laves phase known as an intermetallic compound such as Fe₂W, Fe₂Mo, and Fe₂Nb is formed in the mother phase of the housing 2. Although the Laves phase improves the proof stress at room temperature and at high temperatures, the Laves phase increases the deformation resistance and decreases the toughness. Thus, it is desired that the content of the Laves phase be small. The heat treatment for dissolving the Laves phase in the base material of the housing 2 is preferably 850° C. or more, and more preferably 850 to 1000° C. As a result of the study by the inventors, it was found that heating the material of the housing 2 to a heat treatment temperature of 850° C. or more reduces the content of the Laves phase and improves the processability of the material of the housing 2 at room temperature. The temperature of the heat treatment is predicted by calculating the equilibrium condition between metals in the housing 2, and the Laves component is adjusted as required by the composition of the additive in the housing 2.

The precipitation amount of the Laves phase in the mother phase of the housing 2 is preferably less than 0.1% by mass. If the precipitation amount becomes 0.1% by mass or more, the toughness of the material may possibly decrease significantly.

If the temperature of the heat treatment that heats the material of the housing 2 is too low, the Laves component is not sufficiently dissolved. This may undesirably deteriorate the toughness. However, if the temperature of the heat treatment is too high, the precipitate of NbC and the ferrite crystal grain coarsen, which deteriorates the toughness of the material. In this case, foreign matter such as scale may undesirably be generated during the heat treatment. This may possibly increase the input energy necessary for the heat treatment and deteriorate the manufacturing costs.

When the temperature of the heat treatment is set to a higher temperature of 1250° C. or more, NbC dissolves in the material of the housing 2. However, besides the coarsening of the ferrite crystal being a concern, it is difficult to perform the heat treatment at 1250° C. or more on the material of the housing 2 that has been subjected to wire drawing.

### (Manufacturing Method)

Next, a method for manufacturing the housing 2 and the gas sensor 1 will be briefly described.

Manufacturing the housing 2 of the present embodiment involves melting the metal material such as Fe, Nb, W, Mn, Si, Ni, and Al, drawing the metal material to an elongated member having a predetermined cross-sectional shape, subjecting the metal material to the solid solution heat treatment, shearing the elongated metal material to form individual metal workpieces, subjecting each metal workpiece to cold forging to shape the metal workpiece into the housing 2, and cutting the metal workpiece in the shape of the housing 2 to form the final shape of the housing 2 before mounting. In particular, since Fe contains Ni, the toughness of the metal material is improved, which facilitates executing the shearing and the cold forging of the metal material.

When the gas sensor 1 is manufactured, the crimped portion 24 of the housing 2 is deformed to secure by crimping. When the housing 2 is mounted during the manufacture of the gas sensor 1, the insulator 4, in which the sensor element 3 is retained, is placed in the retaining hole 21 of the housing 2 as shown in FIG. 2. The sealing member 51, the insulation member 52, and the metal ring 53 are placed in the gap S1 between the insulator 4 and the retaining hole 21 of the housing 2. The entire circumference of the proximal end section 240 of the housing 2 is bent inward to secure it by crimping. The crimping may be performed by thermal crimping, in which the proximal end section 240 is heated to a high temperature to be easily deformed.

The heating of the proximal end section 240 is performed by applying current to the proximal end section 240 of the housing 2 to heat a thick small-diameter portion 241 of the proximal end section 240 to a temperature of 550° C. or more to 1000° C. or less. At this time, since the material constituting the housing 2 contains a suitable amount of Nb and a limited additive amount of C and N, the concentration of Cr in Fe is suppressed from being decreased, and the material constituting the proximal end section 240 is suppressed from being sensitized. Thus, the corrosion resistance of the material constituting the housing 2 is maintained.

Furthermore, after the proximal end cover 62 is mounted on the outer circumference of the crimped portion 24 of the housing 2, a mounting portion 623 (refer to FIG. 2) of the proximal end cover 62 is welded to the housing 2 in some cases. In such a case, the crimped portion 24 is heated to 550° C. or more and 1000° C. or less by the heat caused during welding. At this time also, since the material constituting the housing 2 contains a suitable amount of Nb and a limited additive amount of C and N, the concentration of Cr in Fe is suppressed from being decreased, and the material constituting the proximal end section 240 is suppressed from being sensitized. Thus, the corrosion resistance of the material constituting the housing 2 is maintained.

### (Hardness of the Housing 2)

The hardness of the crimped portion 24 of the housing 2 of the present embodiment is within the range of Hv220 to Hv400 in Vickers hardness at least in the product shipment state of the gas sensor 1. Thus, the proof stress of the material constituting the housing 2 is high, and the permanent deformation of the housing 2 is suppressed. The Vickers hardness is a value obtained in accordance with “Vickers Hardness Test” of Japanese Industrial Standard (JIS) Z 2244. JIS Z 2244 corresponds to ISO6507 of ISO standard.

If the hardness of the housing 2 manufactured by cold forging is less than Hv220, the proof stress is low even at room temperature. Thus, when the gas sensor 1 is mounted to the exhaust pipe, the threaded portion 22 and the flange portion (hexagonal section) 23 may undesirably be damaged. Furthermore, if the hardness of the crimped portion 24 is less than Hv220, during crimping, sections other than the crimped portion 24 may possibly be deformed unintentionally. It is undesirable to make the hardness of the crimped portion 24 exceed Hv400 due to manufacturing difficulty and since a crack may undesirably occur by deformation.

When the metal material for forming the housing 2 is subjected to annealing in which the metal material is heated to a temperature of approximately 780° C., the Vickers hardness that can be obtained is approximately Hv160 to Hv180. In contrast, the metal material for forming the housing 2 of the present embodiment is heated to 850 to 1000° C. to conduct the solid solution heat treatment. Thus, the housing 2 achieves a Vickers hardness of Hv220 or more.

Since the material constituting the housing 2 includes the above-mentioned contents of, for example, Nb, W, and Ni dissolved in the material, the high-temperature strength is improved. Furthermore, since the housing 2 is formed by cold forging, a grain flow (fiber flow) appears in the metal structure of the material constituting the housing 2. This maintains the hardness of the housing 2 to be high.

### (Operational Advantage)

In the gas sensor 1 of the present embodiment, since the material constituting the housing 2 has the above-mentioned composition, the strength of the crimped portion 24 of the housing 2 is suppressed from being decreased under high-temperature environments of 550° C. or more. The material constituting the housing 2 contains, by mass, 0.01 to 1.0% of Nb and 0.5 to 4% of W in Fe besides Cr. Thus, the permanent deformation of the housing 2 is suppressed at high temperatures of 550° C. or more. As a result, even under high-temperature environments of 550° C. or more, the crimped portion 24 of the housing 2 maintains the force to compress the sealing member 51, so that the sealing member 51 maintains the airtightness of the gap 51 between the retaining hole 21 of the housing 2 and the sensor element 3 or the insulator 4.

Consequently, the gas sensor 1 of the present embodiment suppresses the permanent deformation of the housing 2 and ensures the airtightness of the gas sensor 1 under high-temperature environments.

Since the gas sensor 1 of the present embodiment is used as the A/F sensor, maintaining the airtightness of the gas sensor 1 achieves the following advantages.

In the A/F sensor, since the high-temperature strength of the crimped portion 24 of the housing 2 is maintained, the exhaust gas G is prevented from being mixed with the air A taken into the sensor element 3. This prevents the inside of the duct 34 of the sensor element 3 from being filled with the exhaust gas G instead of the air A. Thus, in particular, when the air-fuel ratio of the internal combustion engine obtained from the exhaust gas G is in the fuel-rich condition, an event in which the oxide ions (O²⁻) cannot be transferred from the reference electrode 32B to the detection electrode 32A through the solid electrolyte 31 is prevented from occurring. As a result, when the A/F sensor detects the air-fuel ratio in the fuel-rich condition, the wide coverage of the detection range of the fuel-rich condition is maintained. The coverage of the detection range refers to the range (scale) in which the air-fuel ratio in the fuel-rich condition can be detected in a predetermined error range.

Even if the gas sensor 1 is not used as the A/F sensor, since the airtightness of the gas sensor 1 is maintained, the following advantage is achieved.

In the gas sensor 1, since the high-temperature strength of the crimped portion 24 of the housing 2 is maintained, the exhaust gas G is prevented from being mixed with the air A taken inside the sensor element 3. This prevents the exhaust gas G from directly contacting the metal contact terminals 54, which contact the sensor element 3. Thus, the contact terminals 54 are prevented from being corroded by, for example, moisture or nitrogen compounds in the exhaust gas G. These advantages are achieved in both the case with the A/F sensor and the case with the oxygen sensor.

### <Verification Test>

### (Test 1)

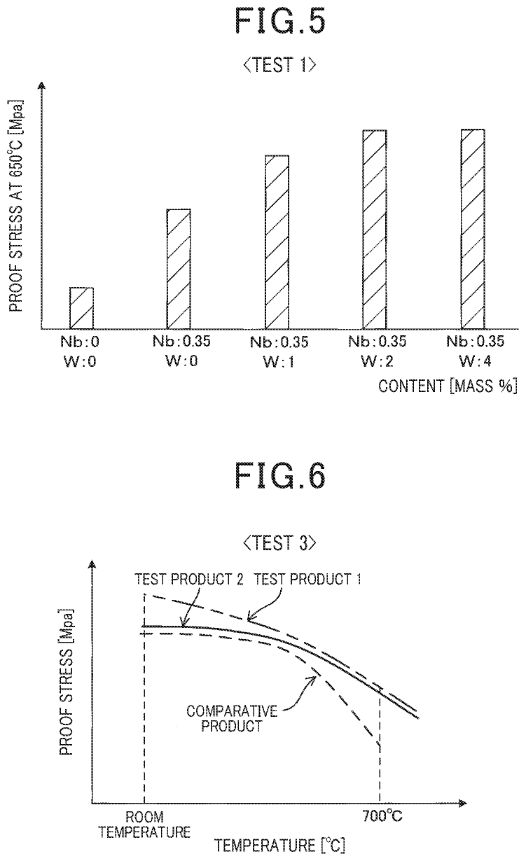

In Test 1, the relationship between the material constituting the housing 2 and the proof stress was measured. FIG. 5 shows changes in the proof stress (MPa) of alloy steel containing, by mass, 17% of Cr and 0.35% of Nb in Fe at 650° C. when the content of W was changed to 0%, 1%, 2%, and 4% by mass. The figure indicates that as the content of W increases, the proof stress increases.

As used herein, the proof stress refers to the elastic limit (yield point). Since the material also contains material that does not clearly show the yield point, as the scale of the strength of the material, 0.2% proof stress is used instead of the yield point. The 0.2% proof stress was measured in accordance with JIS Z 2241 (corresponding international standard: ISO 6892-1) or JIS G 0567 (corresponding international standard: ISO 6892-2).

However, when the content of W exceeds 2% by mass, the yield point no longer increases, and at 2% by mass, the increase in the yield point is saturated. When the content of W increases, the processability such as ductility deteriorates. Thus, it was found that the content of W in the material constituting the housing 2 is preferably 2% or less by mass. If the content of W is excessively small, the yield point also decreases. Thus, the content of W is preferably 0.3% or more by mass.

Note that, Mo has the same property as W. If the material constituting the housing 2 contains Mo instead of W, the content of Mo is also preferably 0.3 to 2% by mass.

### (Test 2)

In Test 2, the airtightness was examined with the housing 2 of a test product formed using alloy steel containing, by mass, 17% of Cr, 0.35% of Nb, and 2% of W in Fe and with the housing 2 of a comparative product formed using stainless steel (grade 430) containing 17% of Cr by mass in Fe. In Test 2, the gas sensor 1 was formed using each housing 2. It was determined whether leakage of exhaust gas G occurred in the gap S1 between the retaining hole 21 of the housing 2 and the insulator 4 in each gas sensor 1.

In Test 2, 3000 cycles of heating and cooling the housing 2 were performed. Each cycle involves heating the hexagonal section of the housing 2 (the section where the outer diameter is the greatest) to 650° C. and then cooling by air to 50° C. or less. While the hexagonal section of the housing 2 was kept heated to 650° C., and the pressure at the sensor element 3 was set to 0.4 MPa, the leakage amount at the gap S1 between the retaining hole 21 of the housing 2 and the insulator 4 was measured. If a leakage of 1 cc/min or more was caused at the gap S1, it was determined that the housing 2 was not airtight. If the leakage of the exhaust gas G at the gap S1 was less than 1 cc/min, it was determined that the housing 2 was airtight.

As a result of conducting the tests, the housing 2 of the comparative product was judged to be not airtight, and the housing 2 of the test product was judged to be airtight. From the result, it was found that with the housing 2 of the test product, the airtightness of the gap S1 between the retaining hole 21 of the housing 2 and the insulator 4 is reliably maintained.

### (Test 3)

In Test 3, the changes in the proof stress when the temperature was changed were examined with the housing 2 of the test product formed using alloy steel containing, by mass, 17% of Cr, 0.35% of Nb, and 2% of W in Fe and with the housing 2 of the comparative product formed using stainless steel (grade 430) containing 17% of Cr by mass in Fe. As the housing 2 of the test product, a test product 1 and a test product 2 were prepared. The test product 1 was obtained by subjecting the material of the housing 2 to an annealing process of heating the material to approximately 780° C. and then cooling. The test product 2 was obtained by subjecting the material of the housing 2 to the solid solution heat treatment of heating the material to approximately 950° C. and then cooling. The housing 2 of the comparative product was subjected to the annealing process of heating to approximately 780° C. and then cooling. The graph of the proof stress of the test products 1 and 2 and the comparative product shows the result in the temperature range from room temperature to 700° C.

As shown in FIG. 6, in the case of the housing 2 of the test product 1, which was subjected to the annealing process, the proof stress is higher than the case of the housing 2 of the comparative product in a wide temperature range. However, since the proof stress at room temperature is also high, the processability at room temperature is poor. In contrast, in the case of the housing 2 of the test product 2, which was subjected to the solid solution heat treatment, the proof stress is higher than the housing 2 of the comparative product only when the temperature is in a high range. In the case of the housing 2 of the test product 2, since the proof stress at room temperature is kept low, the processability at room temperature is good. Thus, it was found that using the housing 2 subjected to the solid solution heat treatment ensures the airtightness of the gas sensor 1 under high-temperature environments and improves the processability of the housing 2 when, for example, cold forging is conducted at room temperature.

### (Test 4)

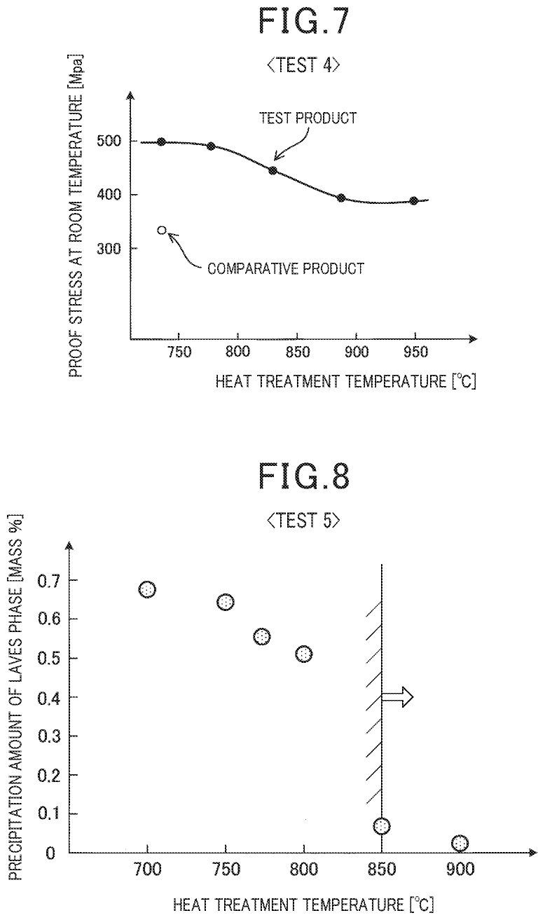

In Test 4, the changes in the proof stress (MPa) at room temperature when the temperature for heat treating the material of the housing 2 was changed were examined with the housing 2 of the test product formed using alloy steel containing, by mass, 17.1% of Cr, 0.35% of Nb, and 2.00% of W in Fe. As shown in FIG. 7, the proof stress at room temperature is high when the temperature of the heat treatment is approximately 750° C. and decreases as the temperature of the heat treatment approaches 900° C. When the temperature of the heat treatment exceeds 900° C., the proof stress does not change.

It can be said that the lower the proof stress at room temperature, the better the processability when the housing 2 is cold forged at room temperature. For comparison, a case in which the proof stress at approximately 750° C. was examined with the housing 2 of the comparative product formed using stainless steel (grade 430) containing 16.8% of Cr by mass in Fe is also shown. Since Nb and W are not added to the comparative product, the proof stress at room temperature is originally low.

With the maximum forming load when cold forging is performed on the housing 2 of the comparative product being used as a reference, it was examined how small the maximum forming load can be reduced when cold forging is performed on the housing 2 of the test product. It was found that in a case in which the heat treatment temperature is set to the temperature for conducting annealing, which is 780° C., the maximum forming load when cold forging is performed is increased by 1.1 times that of the comparative product. In contrast, it was found that in a case in which the heat treatment temperature is set to the temperature for conducting solid solution heat treatment, which is 900° C., the maximum forming load when cold forging is performed is decreased to a load close to the maximum forming load in the case of the comparative product.

Thus, it can be said that performing the solid solution heat treatment at a temperature of 850° C. or more, and more preferably 900° C. or more improves the processability of the material for forming the housing 2 when cold forging is performed. The reason for this is that the heat treatment at a high temperature dissolves the Laves phase, which is a kind of an intermetallic compound such as Fe₂W and Fe₂Mo, in the mother phase of the housing 2. It is known that although the generation of the Laves phase contributes to improving the high-temperature strength, the toughness is significantly decreased. Therefore, the precipitation amount of the Laves phase in the material of the housing 2 is preferably less than 0.1% by mass.

### (Test 5)

In Test 5, which is a material evaluation test, the dissolved state of the Laves phase through the solid solution heat treatment (annealing process) was examined. The composition of the material to be evaluated contains, by mass, 17% of Cr, 0.35% of Nb, 2% of W, 0.02% of C+N, 0.02% of P+S, 0.9% of other inevitable impurities such as Si and Mn, and the balance: Fe. The grain size of the material to be evaluated was adjusted to, by hot forging, the grain size number No. 5 to No. 9, which is the grain size corresponding to that of the wiredrawing material. The material the grain size of which had been adjusted was subjected to heat treatment (annealing process) again, and after leaving it at a predetermined temperature for 4 hours, a quantitative analysis was conducted on the dissolved amount of the Laves phase. The grain size number is specified in JIS G 0551. JIS G 0551 corresponds to ISO643 of the ISO standards.

FIG. 8 shows how much the Laves phase precipitated in the mother phase when the heat treatment temperature was changed from 700 to 900° C. As shown in the graph, as the heat treatment temperature increases, the precipitation amount (mass %) of the Laves phase decreases, so that the Laves phase is dissolved in the mother phase by a greater amount. In particular, it was found that when the heat treatment temperature becomes 850° C. or more, the precipitation amount of the Laves phase becomes less than 0.1% by mass. Thus, it is inferred that setting the heat treatment temperature to 850° C. or more dissolves a greater amount of the Laves phase in the mother phase and improves the processability at room temperature.

The temperature that dissolves the Laves phase in the mother phase can be predicted from the calculation of the equilibrium state between two metals. Since the heat treatment temperature changes in accordance with the composition of the material constituting the housing 2, the heat treatment temperature may be set to a temperature higher than 850° C. as required.

Various quantitative analysis methods for the Laves phase are known. An example of the methods will be shown below.

One of the quantitative analysis methods for the Laves phase may be an extracted residue analysis method. In the extracted residue analysis method, the precipitates in specimens of as-received material and aged material are extracted and separated. The precipitates are further separated into the Laves phase and other precipitates (such as carbide and nitride) to conduct the quantitative analysis. In the extracted residue analysis method, electrolysis extraction is conducted, and more specifically, using 10% acetylacetone-1% tetramethylammonium chloride-methanol solution as an electrolyte solution, a constant-current electrolysis method with a current density of 20 mA/cm² is used. After the electrolysis was conducted, filtration was performed using a nuclepore filter having a bore diameter of 0.2 μm to separate into a filtrate and a residue. The precipitates such as NbC and the Laves phase were separated by a weight analysis and an X-ray diffraction analysis (XRD analysis) of the residue.

### (Test 6)

In Test 6, which is a test for examining the composition, the compositions of specimens 1 to 7 to be evaluated were changed as required, and the relationship between the composition with respect to the 0.2% proof stress and the room temperature processability was examined. The composition of the material to be evaluated and the manner in which the heat treatment of the material was conducted were the same as those in Test 5.

The basic composition of the specimens 1 to 7 is a composition containing, by mass, 16.8 to 17.1% of Cr, 0 or 0.35% of Nb, 0 to 4% of W, 0.02% of C+N, 0.02% of P+S, 0.9% of other inevitable impurities such as Si and Mn, and the balance: Fe. In the specimens 1 to 7, the content of W was changed, and Mo or Ni was contained as required.

The composition of the specimens 1 to 7 and test results are shown in Table 1.

TABLE 1

| | | | | | | | | | Room Temperature Processability | | | |
|---|---|---|---|---|---|---|---|---|---|---|---|---|
| | | | | | | Heat | 0.2% Proof | | | | Ductile Brittle | |
| | | | | | | Treatment | Stress | | Deformation | | Transition | |
| | Composition [mass %] | | | | | Temperature | [MPa] | | Resistance | Elongation | Temperature | |
| | Cr | Nb | W | Mo | Ni | [° C.] | at 650° C. | Judgement | [MPa] | [%] | [° C.] | Judgement |
| Specimen 1 | 16.8 | — | — | — | — | 780 | 60 | Poor | 620 | 44 | 10 | Excellent |
| Specimen 2 | 17.1 | 0.35 | 2.00 | — | — | 780 | 114 | Excellent | 880 | 30 | 40 | Poor |
| Specimen 3 | 17.0 | 0.35 | 1.02 | — | — | 900 | 85 | Excellent | 720 | 42 | 20 | Excellent |
| Specimen 4 | 17.1 | 0.35 | 2.00 | — | — | 900 | 102 | Excellent | 740 | 41 | 20 | Excellent |
| Specimen 5 | 17.0 | 0.35 | 3.99 | — | — | 900 | 108 | Excellent | 820 | 38 | 40 | Poor |
| Specimen 6 | 17.0 | 0.35 | — | 2.01 | — | 900 | 100 | Excellent | 740 | 42 | 20 | Excellent |
| Specimen 7 | 17.0 | 0.35 | 2.00 | — | 1.12 | 900 | 104 | Excellent | 790 | 42 | 10 | Excellent |

The 0.2% proof stress at 650° C. is shown as a value obtained by conducting a static tensile test on a JIS No. 4 test piece. When the 0.2% proof stress was 80 MPa or more, which is the proof stress necessary for maintaining airtightness, it was judged to be a good product (Excellent), and others were judged to be not a good product (Poor). The determination criterion of the 0.2% proof stress depends on the product shape and is not absolute.

The room temperature processability was measured as the deformation resistance at room temperature (20° C.), the elongation at room temperature, and the ductile brittle transition temperature.

The deformation resistance at room temperature is indicated as a value at 70% compression by a cylindrical compression test (distortion speed 6.0/sec) simulating cold forging. When the deformation resistance was less than 800 MPa, it was judged to be a good product (Excellent), and others were judged to be not a good product (Poor). The determination criterion of the deformation resistance depends on the forging process and is not absolute.

The elongation at room temperature is indicated as a value obtained by conducting the static tensile test on a JIS No. 4 test piece. When the elongation was such that no fracture occurs during forging, it was judged to be a good product. The determination criterion of the elongation depends on the forging process and is not absolute.

The toughness transition temperature is indicated as a value obtained by conducting a Charpy impact test (2 mm V-notch, evaluation every 10° C.). Based on the criterion that no fracture occurs during cutting and forging of the wiredrawing material, when the toughness transition temperature was lower than room temperature, which is 25° C., it was judged to be a good product (Excellent), and other cases were judged to be not a good product (Poor). The ductile brittle transition temperature refers to a predetermined temperature below which the material loses toughness and becomes weak against an impact. In the Charpy impact test, an energy of 50 J/cm² was applied to conduct the test.

In Table 1 showing the results of Test 6, for the specimen 1, which has the composition of the current housing 2 of the gas sensor 1 and does not contain Nb and W, the judgment of the 0.2% proof stress was poor. Although the content of Nb and W is appropriate, for the specimen 2, which has been subjected to the heat treatment at a temperature of 780° C., the judgment of the elongation at room temperature was poor. Although Nb and W are contained, for the specimen 5, in which the content of W is greater than 2% by mass, the judgment of the elongation at room temperature was poor.

The specimens 3, 4, and 7, which have an appropriate content of W, which is 1% or 2% by mass, and are treated at an appropriate heat treatment temperature of 900° C., were found to be excellent in the 0.2% proof stress and the processability at room temperature. The specimen 6, which contains Mo instead of W, and the specimen 7, which contains Ni together with W, were found to be excellent in the 0.2% proof stress and the processability at room temperature.

As the result of Test 6, it was found that the 0.2% proof stress at 650° C. is improved with the specimen 2, which contains appropriate Nb and W, compared with the specimen 1, the composition of which is often used in the housing 2 of the current gas sensor 1. However, according to the specimen 2, since the heat treatment temperature is as low as 780° C., so that the Laves phase remains in the structure of the material, the room temperature processability and, in particular, the toughness deteriorates significantly.

Compared with the specimen 2, according to the specimens 3 and 4, which were treated at a heat treatment temperature of 900° C., although the 0.2% proof stress at 650° C. decreased, improvement in the room temperature processability was observed due to the decrease in the deformation resistance at room temperature, the improvement of the elongation, and the decrease in the toughness transition temperature. According to the specimens 3 to 5, the content of W was changed. It was found that when the content of W reaches 2% by mass, the 0.2% proof stress at 650° C. is saturated, and when the content of W exceeds 2% by mass, the deterioration of the room temperature processability becomes significant.

Since the specimen 6 contains 2% Mo by mass instead of W, it was found that the 0.2% proof stress and the room temperature processability that are the same as those of the specimen 4, which contains W, are obtained. Since the specimen 7 contains, by mass, 2% W and 1% Ni, it was found that although the deformation resistance at room temperature is increased, the toughness transition temperature is improved.

### (Test 7)

In Test 7 for product evaluation, a test for examining the airtightness of the housing 2 having the composition of the specimens 1, 3, and 4 of Test 6 was conducted. The housing 2 with each composition was formed by cold forging. The gas sensor 1 using the housing 2 with each composition was mounted on the pipe, and gas at 650° C. and 0.4 MPa (gauge pressure) was passed through the pipe. At this time, the leakage amount of the gas at the crimped portion 24 of the housing 2 of the gas sensor 1 was measured.

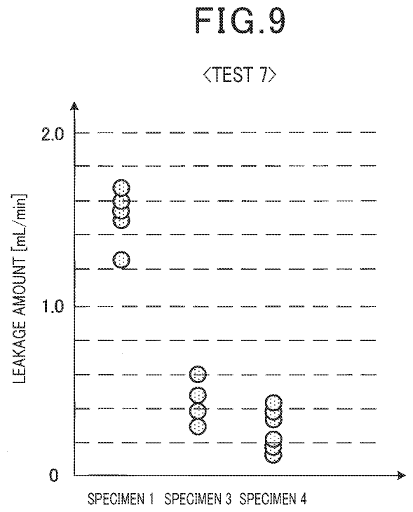

FIG. 9 shows the result of the measurement of the leakage amount according to the gas sensors 1 having the compositions of specimens 1, 3, and 4. The leakage amount is indicated as a value in a normal state. As shown in the graph, it was found that the leakage amount of specimens 3 and 4 was less than 1.0 mL/min, and the airtightness of the housing 2 was ensured. With specimen 1, it was found that the leakage amount increased to exceed 1.0 mL/min, and the airtightness of the housing 2 was poor. Thus, it was found that when the material constituting the housing 2 contains 1.02% or 2.00% of W by mass as the specimens 3 and 4, the 0.2% proof stress at 650° C. is maintained high, and the airtightness of the housing 2 is maintained high. When the material constituting the housing 2 contains 4% of W by mass, the processability at room temperature is poor. Thus, the content of W in the material constituting the housing 2 is preferably 2% or less by mass.

The present disclosure is not limited to the above embodiments, and different embodiments may be further be configured without departing from the scope of the disclosure. The present disclosure embraces various modifications and deformations that come within the scope of equivalent.

What is claimed is:

1. A gas sensor comprising:
a housing including a retaining hole;
a sensor element including a solid electrolyte and electrodes located on both sides of the solid electrolyte, and the sensor element being inserted in the retaining hole alone or via an insulator; and
a sealing member formed of a ceramic powder that fills a gap between the retaining hole and the sensor element or the insulator, and
the sealing member is compressed by part of the housing to seal the gap, wherein
the material constituting the housing is formed of ferritic stainless steel containing, by mass, 15 to 25% of Cr, 0.01 to 1.0% of Nb, 0.5 to 4% of W alone or both of W and Mo in total, and the balance: Fe and inevitable impurities including C, N, Mn and Si.

2. A gas sensor comprising:
a housing including a retaining hole;
a sensor element including a solid electrolyte and electrodes located on both sides of the solid electrolyte, and the sensor element being inserted in the retaining hole alone or via an insulator; and
a sealing member formed of a ceramic powder that fills a gap between the retaining hole and the sensor element or the insulator, and
the sealing member is compressed by part of the housing to seal the gap, wherein
the material constituting the housing is formed of ferritic stainless steel containing, by mass, 15 to 25% of Cr, 0.01 to 1.0% of Nb, 0.5 to 4% of at least one of W and Mo alone or in total, and the balance: Fe and inevitable impurities including C, N, Mn and Si, wherein
a precipitation amount of Laves phase in a mother phase of the housing is less than 0.1% by mass.

3. The gas sensor according to claim 1, wherein Laves phase of Fe₂W, or Fe₂W and Fe₂Mo as intermetallic compounds is formed in a mother phase of the housing, and
a precipitation amount of Laves phase in the mother phase of the housing is less than 0.1% by mass.

4. The gas sensor according to claim 2, wherein Laves phase of Fe₂W, or Fe₂W and Fe₂Mo as intermetallic compounds is formed in a mother phase of the housing.

5. The gas sensor according to claim 1, wherein the housing has a 0.2% proof stress of 80 MPa or more at 650° C.

6. The gas sensor according to claim 1, wherein the material constituting the housing contains 0.05% or less of C by mass.

7. The gas sensor according to claim 1, wherein the material constituting the housing further contains 0.1 to 0.6% of Ni by mass.

8. The gas sensor according to claim 1, wherein a hardness of a crimped portion of the housing is within a range of Hv220 to Hv400 in Vickers hardness.

9. The gas sensor according to claim 1, further comprising:
a heater including a heating element, which heats the sensor element; and
a contact terminal, which contacts a lead portion of the electrodes of the sensor element or a lead portion of the heating element.
